(19) United States
(12) Patent Application Publication
(10) Pub. No.: US 2021/0229526 A1
(43) Pub. Date: Jul. 29, 2021

(54) SYSTEM AND METHOD FOR CONTROLLING AN AIRFLOW SUPPLIED TO A CABIN OF A WORK VEHICLE

(71) Applicant: CNH Industrial America LLC, New Holland, PA (US)

(72) Inventors: Robert C. Fiocchi, Chicago, IL (US); Kaushal Ghorpade, Chicago, IL (US); Panos Tamamidis, Mount Prospect, IL (US); Leonid Chernyavsky, Glenview, IL (US); Samrendra Singh, Bolingbrook, IL (US)

(73) Assignee: CNH Industrial America LLC

(21) Appl. No.: 16/750,218

(22) Filed: Jan. 23, 2020

(51) Int. Cl. B60H 1/24; B60H 1/00

(52) U.S. Cl. CPC B60H 1/247; B60H 2001/00178; B60H 1/00664

(57) ABSTRACT

A system for controlling an airflow supplied to a cabin of a work vehicle may include a housing defining a mixing chamber and a recirculating chamber isolated from the mixing chamber. The mixing chamber is configured to receive fresh air via a fresh air inlet and recirculated air via a first recirculated air inlet, with the fresh air being mixed with the recirculated air within the mixing chamber to create a fresh/recirculated air mixture that is supplied through a mixed air outlet. The recirculating chamber is configured to receive recirculated air via a second recirculated air inlet and supply the recirculated air through a recirculated air outlet. Additionally, the system may include a gate movable relative to the first recirculated air inlet to adjust an amount of recirculated air supplied to the mixing chamber, and an actuator configured to actuate the gate relative to the first recirculated air inlet.

### FIELD OF THE INVENTION

The present disclosure relates generally to work vehicles and, more particularly, to a system and a method for controlling an airflow supplied to a cabin of a work vehicle.

### BACKGROUND OF THE INVENTION

Work vehicles, such as tractors and other agricultural vehicles, typically include heating, ventilation, and air conditioning (HVAC) systems. These systems heat and cool the air within a cabin of the work vehicle for the comfort of an operator of the vehicle. Some vehicle HVAC systems can be configured to change the ratio between fresh air, drawn from outside of the cabin of the work vehicle, and recirculated air, drawn from inside of the cabin of the work vehicle. By changing the ratio between fresh and recirculated air, window fogging can be prevented, operator comfort may be improved, and fuel economy may be enhanced, for example.

However, many HVAC systems allow for the recirculated air to be completely shut off such that only fresh air is drawn in. Such HVAC systems may, thus, impair the fuel economy of the work vehicle by increasing the load on the compressor of the HVAC system. Further, many HVAC systems rely on independent adjustment of a fresh air inlet and a recirculation air inlet to control the ratio of fresh air to recirculated air.

Accordingly, an improved system and method for controlling an airflow supplied to a cabin of a work vehicle would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for controlling an airflow supplied to a cabin of a work vehicle. The system includes a housing, a mixing chamber defined by the housing, and a recirculating chamber defined by the housing and isolated from the mixing chamber. The mixing chamber has a fresh air inlet, a first recirculated air inlet, and a mixed air outlet. The mixing chamber is configured to receive fresh air via the fresh air inlet and recirculated air via the first recirculated air inlet, with the fresh air being mixed with the recirculated air within the mixing chamber to create a fresh/recirculated air mixture that is supplied through the mixed air outlet. The recirculating chamber has a second recirculated air inlet and a recirculated air outlet, with the recirculating chamber being configured to receive recirculated air via the second recirculated air inlet and supply the recirculated air through the recirculated air outlet. The system further includes a first blower coupled to the mixed air outlet of the mixing chamber and a second blower coupled to the recirculated air outlet of the recirculating chamber. Additionally, the system includes a gate movable relative to the first recirculated air inlet to adjust an amount of recirculated air supplied to the mixing chamber, and an actuator configured to actuate the gate relative to the first recirculated air inlet.

In another aspect, the present subject matter is directed to a work vehicle, having a cabin and an airflow control system. The airflow control system includes a housing, a mixing chamber defined by the housing, and a recirculating chamber defined by the housing and isolated from the mixing chamber. The mixing chamber has a fresh air inlet, a first recirculated air inlet, and a mixed air outlet, with the mixing chamber being configured to receive fresh air via the fresh air inlet and recirculated air via the first recirculated air inlet. The fresh air is mixed with the recirculated air within the mixing chamber to create a fresh/recirculated air mixture that is supplied through the mixed air outlet. The recirculating chamber has a second recirculated air inlet and a recirculated air outlet, with the recirculating chamber being configured to receive recirculated air via the second recirculated air inlet and supply the recirculated air through the recirculated air outlet. The airflow control system further includes a first blower coupled to the mixed air outlet of the mixing chamber and configured to blow the fresh/recirculated air mixture from the mixing chamber into the cabin, and a second blower coupled to the recirculated air outlet of the recirculating chamber and configured to blow the recirculated air from the recirculating chamber into the cabin. Additionally, the airflow control system includes a gate movable relative to the first recirculated air inlet to adjust an amount of recirculated air supplied to the mixing chamber, and an actuator configured to actuate the gate relative to the first recirculated air inlet.

In an additional aspect, the present subject matter is directed to a method for adjusting the proportion of recirculated air to fresh air received within an airflow control system for subsequent delivery to a cabin of a work vehicle. The airflow control system has a housing defining a mixing chamber and a recirculating chamber, where the mixing and recirculating chambers are isolated from each other. The mixing chamber has a fresh air inlet and a first recirculated air inlet, with the mixing chamber being configured to receive fresh air via the fresh air inlet and recirculated air via the first recirculated air inlet. The recirculating chamber has a second recirculated air inlet through which it is configured to receive recirculated air. The airflow control system further includes a gate movable relative to the first recirculated air inlet to adjust an amount of recirculated air supplied to the mixing chamber. The method includes supplying an airflow exhausted from an outlet of the mixing chamber into the cabin of the work vehicle. Further, the method includes supplying an airflow exhausted from an outlet of the recirculating chamber into the cabin of the work vehicle. Moreover, the method includes receiving, with a computing device, airflow data indicative of an airflow parameter associated with operation of the airflow control system. Additionally, the method includes actuating, with the computing device, the gate relative to the recirculated air inlet to adjust an amount of recirculated air received within the mixing chamber via the first recirculated air inlet based at least in part on the airflow data.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter;

FIG. 2 illustrates a perspective view of an airflow control system of the work vehicle shown in FIG. 1 in accordance with aspects of the present subject matter;

FIG. 3 illustrates a perspective view of a gate of the airflow control system shown in FIG. 2 in accordance with aspects of the present subject matter;

FIG. 4 illustrates another perspective view of the airflow control system shown in FIG. 2 in accordance with aspects of the present subject matter;

FIG. 5 illustrates a section view of the airflow control system shown in FIG. 2 in accordance with aspects of the present subject matter, particularly illustrating the cross-section taken at section line 5-5 of FIG. 2;

FIG. 6 illustrates a perspective section view of the airflow control system shown in FIG. 4 in accordance with aspects of the present subject matter, particularly illustrating the cross-section taken at section line 6-6 of FIG. 4;

FIG. 7A illustrates a section view of the airflow control system shown in FIG. 4 taken at section line 7-7 of FIG. 4 in accordance with aspects of the present subject matter, particularly illustrating a fully opened position of a gate of the airflow control system;

FIG. 7B illustrates similar section view of the airflow control system as that shown in FIG. 7A in accordance with aspects of the present subject matter, particularly illustrating a fully closed position of the gate of the airflow control system;

FIG. 7C illustrates similar section view of the airflow control system as that shown in FIG. 7A in accordance with aspects of the present subject matter, particularly illustrating a partially closed position of the gate of the airflow control system;

FIG. 8 illustrates a schematic view of a system for controlling an airflow supplied to a cabin of a work vehicle in accordance with aspects of the present subject matter; and

FIG. 9 illustrates a flow diagram of one embodiment of a method for controlling an airflow supplied to a cabin of a work vehicle in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for controlling an airflow supplied to a cabin of a work vehicle. Specifically, in several embodiments, an airflow control system may include a recirculating chamber and a separate mixing chamber. The recirculating chamber may be configured to supply recirculated air into the cabin, while the mixing chamber may be configured to supply a mixture of fresh and recirculated air into the cabin. Generally, recirculated air has a lower pressure than fresh air. In one embodiment, a controller of the disclosed system may be configured to control the ratio of fresh and recirculated air supplied from the mixing chamber to the cabin. For instance, the controller may be configured to receive airflow data indicative of an airflow parameter associated with operation of the airflow control system. In one embodiment the airflow data may correspond to pressure data indicating the air pressure within the cabin of the vehicle. In such embodiment, the controller may be configured to compare the detected pressure within the cabin of the vehicle to a cabin pressure threshold. In other embodiments, the airflow data may correspond to flowrate data indicating the flow rate of fresh air into the mixing chamber. In such embodiment, the controller may be configured to compare the detected flow rate of the fresh air into the mixing chamber to a flowrate threshold.

When the detected pressure within the cabin differs from the cabin pressure threshold and/or when the detected flow rate of the fresh air differs from the flowrate threshold, the controller may be configured to control an operation of a gate of the airflow control system to adjust the ratio of fresh-to-recirculated air being received within the mixing chamber. In one embodiment, the gate may be positioned at the inlet at which recirculated air is supplied into the mixing chamber and may be movable relative to such recirculated air inlet between a fully opened position, in which the recirculated air inlet may receive a maximum amount of recirculated air, and a fully closed position, in which the recirculated air inlet may receive little to no recirculated air. By moving the gate towards the fully opened position, the flow of recirculated air received within the mixing chamber may increase, which correspondingly decreases the flowrate of fresh air and the pressure within the cabin. Conversely, by moving the gate towards the fully closed position, the flow of recirculated air received within the mixing chamber may decrease, which correspondingly increases the flowrate of fresh air and the pressure within the cabin.

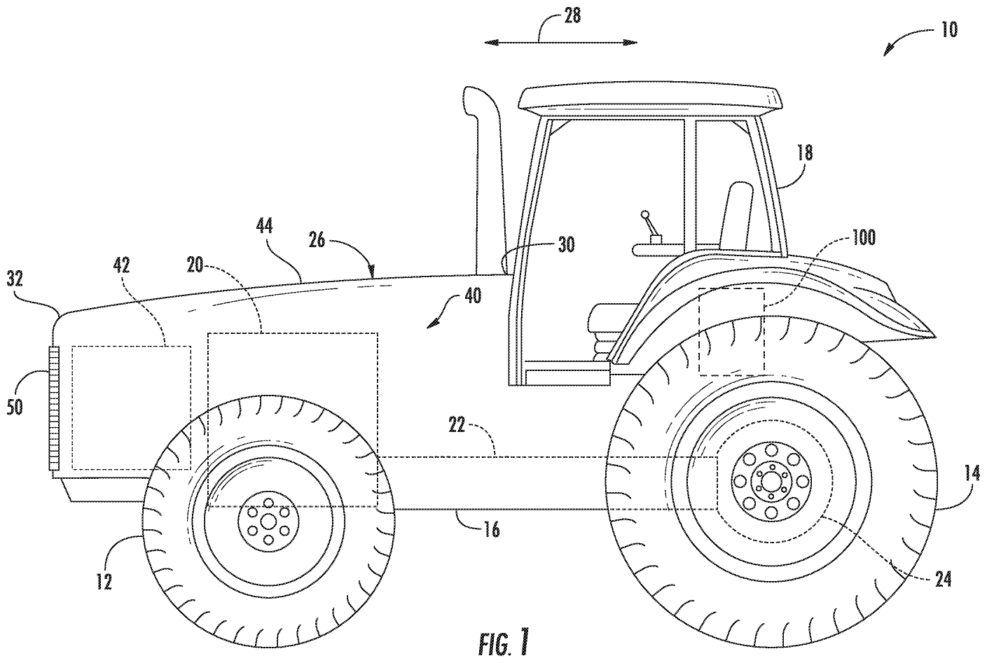

Referring now to drawings, FIG. 1 illustrates a side view of one embodiment of a work vehicle 10 in accordance with aspects of the present subject matter. It should be appreciated that, although the work vehicle 10 illustrated herein is configured as an agricultural tractor, the work vehicle 10 may generally be configured as any suitable work vehicle known in the art, such as various other agricultural vehicles, earth-moving vehicles, road vehicles, loaders and/or the like.

As shown in FIG. 1, the work vehicle 10 includes a pair of front wheels 12, a pair or rear wheels 14, and a chassis 16 coupled to and supported by the wheels 12, 14. An operator's cabin 18 may be supported by a portion of the chassis 16 and may house various control devices (not shown) for permitting an operator to control the operation of the work vehicle 10. Additionally, the work vehicle 10 may include an engine 20 and a transmission 22 mounted on the chassis 16. The transmission 22 may be operably coupled to the engine 20 and may provide variably adjusted gear ratios for transferring engine power to the wheels 12, 14 via a differential 24.

The work vehicle 10 may also include a hood 26 configured to extend in a lengthwise direction of the work vehicle 10 (as indicated by arrow 28 in FIG. 1). As is generally understood, the hood 26 may be configured to least partially surround and/or cover the various under-hood components stored within the vehicle's engine compartment 40, such as the engine 20 and any other suitable under-hood components (e.g., hydraulic components, pneumatic components, electrical components, mechanical component(s), storage tank(s), etc.). For instance, in addition to the engine 20, a cooling system or module 42 of the work vehicle 10 may be positioned within the engine compartment 40, such as at a location in front of the engine 20.

Additionally, in accordance with aspects of the present subject matter, the work vehicle 10 may also include an airflow control system 100 for heating and cooling an interior of the cabin 18. As will be discussed in greater detail below, it may be desirable for the interior of the cabin 18 to be kept at or near a predetermined pressure for the comfort of an operator. As such, the airflow control system 100 may be configured to adjust a ratio of fresh airflow from outside of the cabin 18 to recirculated airflow from inside the cabin 18 which may help maintain a comfortable pressure within the cabin 18.

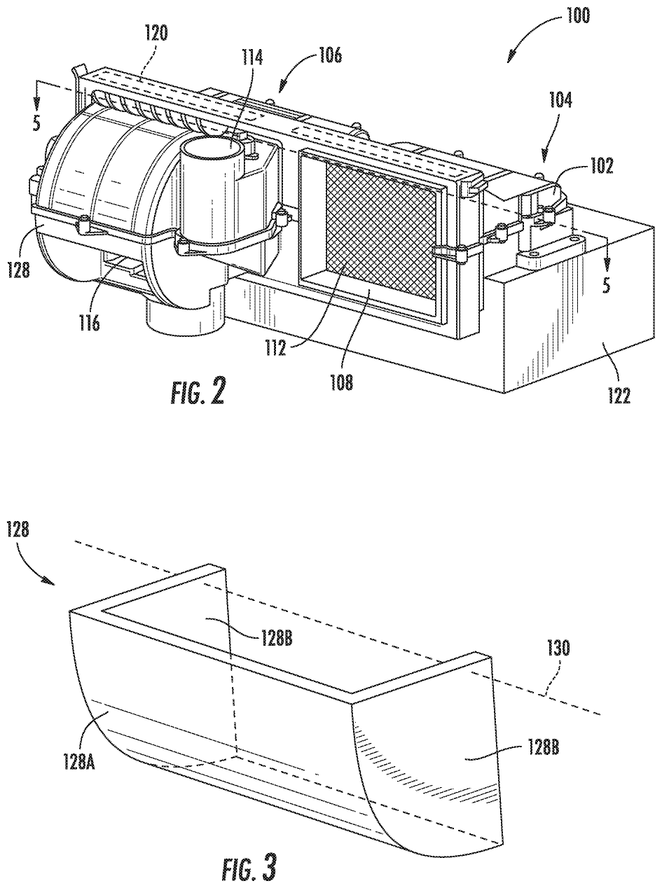

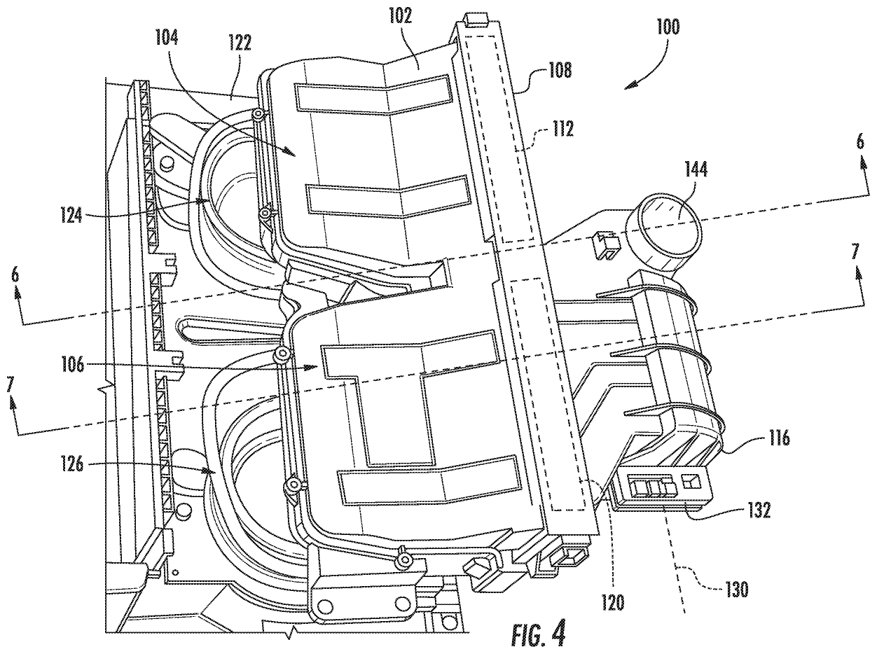

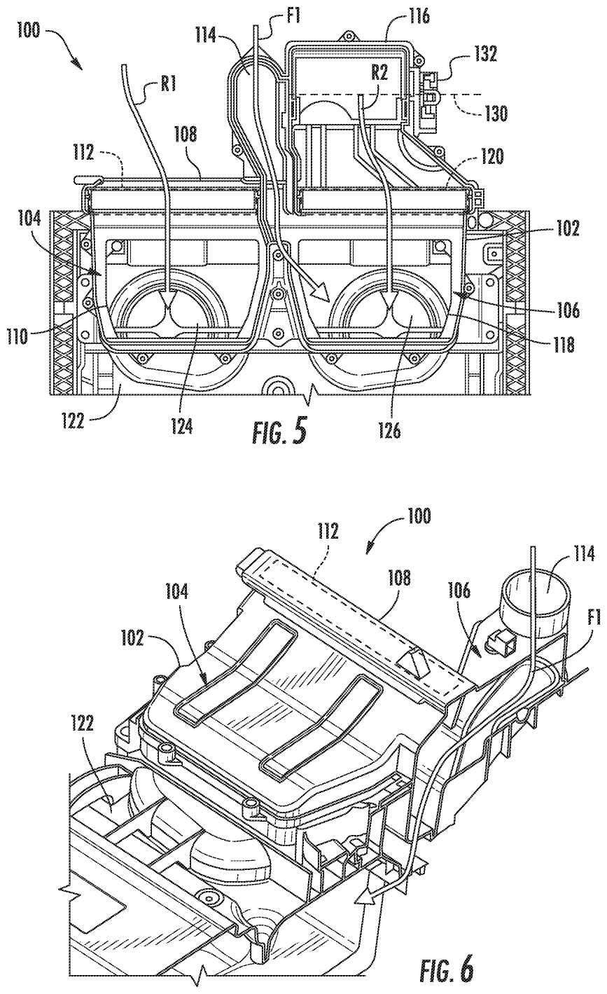

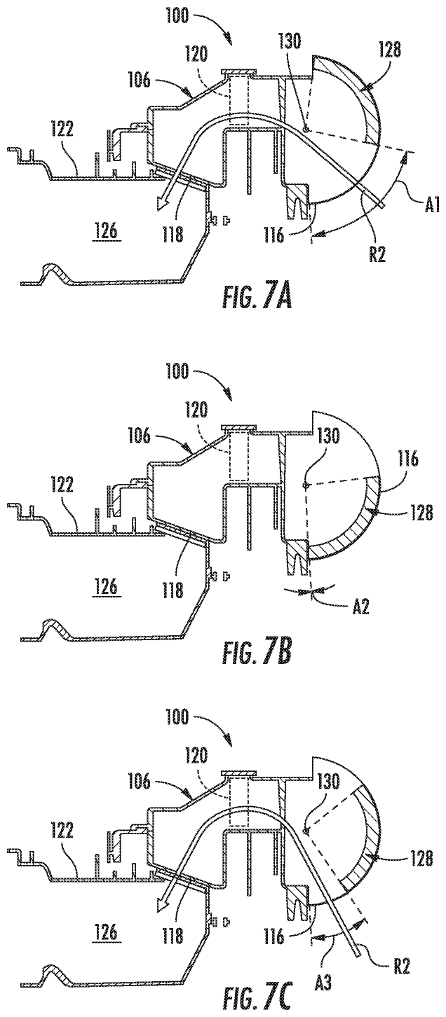

Referring now to FIGS. 2-7C, various views of one embodiment of an airflow control system 100 suitable for use in supplying air to a cabin 18 of a work vehicle (e.g., the cabin 18 of the work vehicle 10 shown in FIG. 1) are illustrated in accordance with aspects of the present subject matter. Referring specifically to the drawings, FIG. 2 illustrates a perspective view of the airflow control system 100. FIG. 3 illustrates a perspective view of a gate of the airflow control system 100 shown in FIG. 2. FIG. 4 illustrates another perspective view of the airflow control system 100. FIG. 5 illustrates a cross-sectional view of the airflow control system 100 of FIG. 2 taken about line 5-5. FIG. 6 illustrates a perspective sectional view of the airflow control system 100 of FIG. 4 taken about line 6-6. Additionally, FIGS. 7A-7C each illustrate a cross-sectional view of the airflow control system 100 of FIG. 4 taken about line 7-7, particularly illustrating different positions of a gate of the airflow control system.

As shown in FIGS. 2, 4, and 5, the airflow control system 100 may include an upper housing 102 and a lower housing 122. The upper housing 102 generally defines a recirculating chamber 104 and a mixing chamber 106, with the recirculating chamber 104 being isolated from the mixing chamber 106. It should be appreciated that the upper housing 102 may be formed such that the portions of the upper housing 102 defining the separate chambers 104, 106 may be formed separately from each other or may be formed together as one piece. As particularly shown in FIGS. 4 and 5, the lower housing 122 supports or houses a recirculation blower 124 and a mixed blower 126. The recirculation blower 124 and the mixed blower 126 are configured to generate a vacuum in the recirculating chamber 104 and the mixing chamber 106, respectively, such that air is drawn through the recirculating chamber 104 and the mixing chamber 106 and into the cabin 18 of the work vehicle 10. The blowers 124, 126 may form part of an air conditioning circuit, in which the air exhausted from the chambers 104, 106 is heated or cooled before exiting into the cabin 18. Similar to the upper housing 102, the lower housing 122 may be formed such that the portions of the lower housing 122 supporting the separate blowers 124, 126 may be formed separately from each other or may be formed together as one piece.

As shown in FIGS. 2 and 4-6, the recirculating chamber 104 of the upper housing 102 has a recirculated air inlet 108 and a recirculated air outlet 110 (FIG. 5). The recirculating chamber 104 is configured to receive a flow of recirculated air (e.g., as shown with arrow R1 in FIG. 5) from inside the cabin 18 of the vehicle 10 via the recirculated air inlet 108. As shown in FIG. 5, the recirculating chamber 104 may include a recirculated air filter 112 positioned at the recirculated air inlet 108 through which the recirculated airflow R1 may pass before being received within the recirculating chamber 104 to remove contaminants, such as dust, dirt, etc. The recirculating chamber 104 may then supply the recirculated airflow R1 to the recirculation blower 124 via the recirculated air outlet 110, and thus back into the cabin 18 of the vehicle 10. The volume of the recirculated airflow R1 may be adjustable based at least in part on the speed of the recirculation blower 124.

Similarly, as shown in FIGS. 2 and 4-6, the mixing chamber 106 may have a fresh air inlet 114, a recirculated air inlet 116, and a mixed outlet 118 (FIG. 5). As shown in FIGS. 5 and 6, the mixing chamber 106 may receive a flow of fresh air (e.g., as shown with arrow F1 in FIGS. 5 and 6) from outside of the cabin 18 of the vehicle 10 via the fresh air inlet 114. The fresh air inlet 114 is always fully open such that the fresh airflow F1 may always be received by the mixing chamber 106. The mixing chamber 106 may also receive a flow of recirculated air (e.g., as shown with arrow R2 in FIGS. 5, 7A, and 7C) from inside the cabin 18 of the vehicle 10 via the recirculated air inlet 116. The mixing chamber 106 may include a recirculated air filter 120 (FIGS. 5, 7A, and 7C) positioned at the recirculated air inlet 116 through which the recirculated airflow R2 may pass before being received within the mixing chamber 106 to remove contaminants, such as dust, dirt, etc. In some embodiments, the fresh airflow F1 may be configured to flow through the recirculated air filter 120 or may flow through a separate air filter (not shown).

Further, as shown in FIG. 5, the fresh air inlet 114 and the recirculated air inlet 116 are separately connected to the mixing chamber 106 such that the recirculated air inlet 116 may be selectively opened, closed, or partially covered/opened (as will be described below) without blocking or covering the fresh air inlet 114. The fresh and recirculated airflow F1, R2 received from the respective inlets 114, 116 may be mixed within the mixing chamber 106 to create a fresh/recirculated air mixture. The fresh/recirculated air mixture may then be supplied through the mixed outlet 118 to the mixed blower 126. The volume of the fresh airflow F1 and the volume of the recirculated airflow R2 may be adjustable based at least in part on the speed of the mixed blower 126.

It should be appreciated that recirculated air may always be supplied to the cabin 18 of the vehicle 10 via the recirculating chamber 104, regardless of whether the mixing chamber 106 is receiving recirculated air. As a result, the efficiency of an air conditioning system downstream of the chambers 104, 106 is improved.

In accordance with aspects of the present subject matter, the volume of the fresh airflow F1 and the volume of the recirculated airflow R2 received by the mixing chamber 106 may further be adjustable by a gate 128. As shown in FIGS. 2 and 7A-7C, the gate 128 is positioned at the recirculated air inlet 116 of the mixing chamber 106 and is movable relative to the recirculated air inlet 116 to selectively cover the recirculated air inlet 116. For instance, the gate 128 is movable by an actuator 132 relative to the recirculated air inlet 116 between a fully opened position (FIG. 7A) and a fully closed position (FIG. 7B). In the fully opened position shown in FIG. 7A, the gate 128 covers the least amount of the recirculated air inlet 116 such that a maximum volume of the recirculated airflow R2 may enter the recirculated air inlet 116. In the fully closed position shown in FIG. 7B, the gate 128 covers substantially all of the recirculated air inlet 116, such that no or substantially no recirculated air enters through the recirculated air inlet 116. It should be appreciated that the actuator 132 may position the gate 128 at any position between the fully opened and closed positions, such as at the partially opened or partially covered position shown in FIG. 7C.

In one embodiment, as shown in FIG. 3, the gate 128 has an outer wall 128A and side walls 128B. The outer wall 128A of the gate 128 is configured to substantially enclose or cover the recirculated air inlet 116 when the gate 128 is in the fully closed position (FIG. 7B) such that no recirculated air may enter the recirculated air inlet 116. The side walls 128B of the gate 128 may be rotatably coupled to the housing 102 such that the gate 128 is rotatable about an axis 130. In such embodiment, the actuator 132 (FIG. 5) may be configured as a rotary actuator that rotates the gate 128 about the axis 130 between the fully opened and closed positions. For example, the rotary actuator 132 may rotate the gate 128 about the axis 130 between a first angular position A1 corresponding to the fully opened position (FIG. 7A) and a second angular position A2 corresponding to the fully closed position (FIG. 7B). The actuator 132 may also rotate the gate 128, for instance, to any position between the fully opened and closed positions, such as an angular position A3 between the first and second angular positions A1, A2 corresponding to a partially opened position (FIG. 7C).

As will be described in greater detail below, when the gate 128 is moved relative to the recirculated air inlet 116 of the mixing chamber 106, the amount of recirculated air supplied to the mixing chamber 106 through the recirculated air inlet 116 changes such that a corresponding change in the amount of fresh air supplied to the mixing chamber 106 through the fresh air inlet 114 occurs, without requiring the fresh air inlet 114 to be partially blocked or covered. For instance, when the gate 128 is moved towards its fully opened position (FIG. 7A), the amount or volume of the recirculated airflow R2 increases such that the amount or volume of the fresh airflow F1 decreases without a change in the speed of the blower(s) 124, 126. The total volume of air supplied to the cabin 18 of the vehicle 10 is greatest when the gate 128 is in its fully opened position. Similarly, when the gate 128 is moved towards its fully closed position (FIG. 7B), the amount or volume of the recirculated airflow R2 decreases such that the amount or volume of the fresh airflow F1 increases without a change in the speed of the blower(s) 124, 126. The total volume of air supplied to the cabin 18 of the vehicle 10 is at a minimum when the gate 128 is in its fully closed position.

Referring now to FIG. 8, a schematic view of one embodiment of a system 200 for controlling an airflow supplied to a cabin of a work vehicle is illustrated in accordance with aspects of the present subject matter. In general, the system 200 will be described with reference to the work vehicle 10 described above with reference to FIG. 1 and the airflow control system 100 described above with reference to FIGS. 2-7C. However, it should be appreciated by those of ordinary skill in the art that the disclosed system 200 may generally be utilized with work vehicles having any other suitable vehicle configuration and/or with an airflow control system having any other suitable configuration.

As shown in FIG. 8, the system 200 may include a controller 202 configured to electronically control the operation of one or more components of the airflow control system 100. In general, the controller 202 may comprise any suitable processor-based device known in the art, such as a computing device or any suitable combination of computing devices. Thus, in several embodiments, the controller 202 may include one or more processor(s) 204, and associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 206 of the controller 202 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 206 may generally be configured to store suitable computer-readable instructions that, when implemented by the processor(s) 204, configure the controller 202 to perform various computer-implemented functions, such as one or more aspects of the methods and algorithms that will be described herein. In addition, the controller 202 may also include various other suitable components, such as a communications circuit or module, one or more input/output channels, a data/control bus and/or the like.

It should be appreciated that, in several embodiments, the controller 202 may correspond to an existing controller of the work vehicle 10. However, it should be appreciated that, in other embodiments, the controller 202 may instead correspond to a separate processing device. For instance, in one embodiment, the controller 202 may form all or part of a separate plug-in module that may be installed within the work vehicle 10 to allow for the disclosed system and method to be implemented without requiring additional software to be uploaded onto existing control devices of the work vehicle 10.

In some embodiments, the controller 202 may be configured to include a communications module or interface 208 to allow for the controller 202 to communicate with any of the various other system components described herein. For instance, the controller 202 may, in several embodiments, be configured to receive data inputs from one or more sensors that are used to detect one or more airflow parameters associated with the operation of the airflow control system 100. For instance, the controller 202 may be communicatively coupled to one or more pressure sensors 210 and/or one or more flowrate sensors 212 via any suitable connection, such as a wired or wireless connection to allow data received from the sensor(s) 210, 212 to be transmitted to the controller 202.

The pressure sensor(s) 210 may be configured to generate pressure data indicative of a pressure inside of the cabin 18. For example, in one embodiment, the pressure sensor(s) 210 may be installed within or otherwise positioned relative to the cabin 18 of the work vehicle 10 to capture pressure data indicative of a pressure within the cabin 18. Thus, in several embodiments, the controller 202 may be configured to determine the pressure within the cabin 18 of the work vehicle 10 based on the data received from the pressure sensor(s) 210. It should be appreciated that the pressure sensor(s) 210 may be configured as any suitable pressure sensor. Similarly, the flowrate sensor(s) 212 may be configured to generate flowrate data indicative of a flowrate of the fresh airflow F1 through the fresh air inlet 114 of the mixing chamber 106. For example, in one embodiment, the flowrate sensor(s) 212 may be installed within or otherwise positioned relative to the fresh air inlet 114 to capture flowrate data indicative of an amount and/or speed of the fresh airflow F1 flowing through the fresh air inlet 114. It should be appreciated that the flowrate sensor(s) 212 may be configured as any suitable flowrate sensor.

The controller 202 may further be configured to determine whether the airflow parameter(s) associated with the operation of the airflow control system 100 is acceptable. For instance, in one embodiment, the controller 202 may include one or more algorithms that compare the detected pressure within the cabin 18 (e.g., as determined from the pressure data received from the pressure sensor(s) 210) to a cabin pressure threshold to determine whether the pressure within the cabin 18 of the work vehicle 10 is acceptable. For example, in one embodiment, the cabin pressure threshold may generally correspond to a desired pressure within the cabin 18. Thus, the controller 202 may determine that the pressure within the cabin 18 is not acceptable when the detected pressure within the cabin 18 differs from the cabin pressure threshold. Particularly, the controller 202 may determine that the pressure within the cabin 18 is not acceptable when the detected pressure within the cabin 18 differs from the cabin pressure threshold by a given amount. It should be appreciated that the cabin pressure threshold may be selected or predetermined.

Similarly, in some embodiments, the controller 202 may include one or more algorithms that compare the detected flowrate of the fresh airflow F1 within the fresh air inlet 114 of the mixing chamber 106 (e.g., as determined from the flowrate data received from the flowrate sensor(s) 212) to a flowrate threshold to determine whether the flowrate of the fresh airflow F1 meets the flowrate requirements for the airflow control system 100. For example, in one embodiment, the flowrate threshold may generally correspond to a desired flowrate of the fresh airflow F1 that will satisfy the current needs of the airflow control system 100. For instance, depending on the current conditions within the cabin 18 of the work vehicle 10, the flowrate requirement of the fresh airflow F1 may change. For example, if an operator of the vehicle 10 requests a defogging operation of the airflow control system 100 or if the pressure within the cabin 18 differs from the cabin pressure threshold, the flowrate requirement of the fresh airflow F1 changes. Thus, the controller 202 may determine that the flowrate of the fresh airflow F1 is not acceptable when the detected flowrate of the fresh airflow F1 differs from the flowrate threshold. Particularly, the controller 202 may determine that the flowrate of the fresh airflow F1 is not acceptable when the detected flowrate of the fresh airflow F1 differs from the flowrate threshold by a given amount.

The controller 202 may further be configured to perform one or more control actions based on the data received from the sensor(s) 210, 212. Specifically, the controller 202 may be configured to control the operation of one or more components of the airflow control system 100 based on the determination of an unacceptable pressure within the cabin 18 of the work vehicle 10 and/or an unacceptable flowrate of the fresh airflow F1. For example, the controller 202 may be configured to control the operation of the gate actuator(s) 132 to adjust an operating parameter of the airflow control system 100 in a manner designed to adjust the pressure within the cabin 18 of the work vehicle 10 and/or the flowrate of the fresh airflow F1.

For instance, in some embodiments, the controller 202 may be configured to control the actuator(s) 132 to adjust the position of the gate 130 when the pressure within the cabin 18 differs from the cabin pressure threshold. In particular, the controller 202 may be configured to control the actuator(s) 132 to move the gate 130 towards its fully closed position to cover more of or all of the recirculated air inlet 116 of the mixing chamber 106 when it is determined that the pressure within the cabin 18 has fallen below the cabin pressure threshold (e.g., by a given amount). In such embodiment, a smaller volume of the recirculated airflow R2 may be drawn through the recirculated air inlet 116, and thus, a larger volume of the fresh airflow F1 may be drawn through the fresh air inlet 114, which may increase the pressure within the cabin 18. Similarly, the controller 202 may be configured to control the actuator(s) 132 to move the gate 130 towards its fully opened position to cover less of the recirculated air inlet 116 of the mixing chamber 106 when it is determined that the pressure within the cabin 18 has exceeded the cabin pressure threshold (e.g., by a given amount). In such embodiment, a larger volume of the recirculated airflow R2 may be drawn through the recirculated air inlet 116, and thus, a smaller volume of the fresh airflow F1 may be drawn through the fresh air inlet 114, which may decrease the pressure within the cabin 18.

In some embodiments, the controller 202 may be configured to control the actuator(s) 132 to adjust the position of the gate 130 when the flowrate of the fresh airflow F1 differs from the flowrate threshold. In particular, the controller 202 may be configured to control the actuator(s) 132 to move the gate 130 towards its fully closed position to cover more of or all of the recirculated air inlet 116 of the mixing chamber 106 when it is determined that the flowrate of the fresh airflow F1 has fallen below the flowrate threshold. In such embodiment, the flowrate of the recirculated airflow R2 may decrease, and thus, the flowrate of the fresh airflow F1 may increase. Similarly, the controller 202 may be configured to control the actuator(s) 132 to move the gate 130 towards its fully opened position to cover less of the recirculated air inlet 116 of the mixing chamber 106 when it is determined that the flowrate of the fresh airflow F1 has exceeded the flowrate threshold (e.g., by a given amount). In such embodiment, the flowrate of the recirculated airflow R2 may increase, and thus, the flowrate of the fresh airflow F1 may decrease.

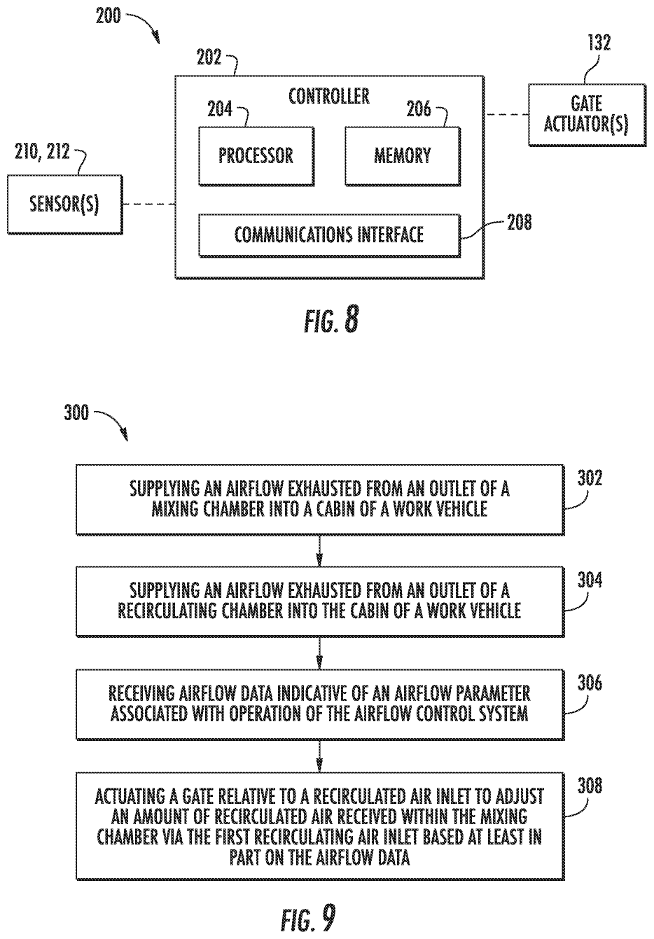

Referring now to FIG. 9, a flow diagram of one embodiment of a method 300 for controlling an airflow supplied to a cabin of a work vehicle is illustrated in accordance with aspects of the present subject matter. In general, the method 300 will be described herein with reference to the work vehicle 10 shown in FIG. 1, as well as the various system components shown in FIGS. 2-8. However, it should be appreciated that the disclosed method 300 may be implemented with work vehicles having any other suitable configurations and/or within systems having any other suitable system configuration. In addition, although FIG. 9 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 9, at (302), the method 300 may include supplying an airflow exhausted from an outlet of a mixing chamber into a cabin of a work vehicle. For instance, as indicated above, the mixing chamber 106 may be configured to receive a fresh airflow F1 via a fresh air inlet 114 and a recirculated airflow R2 via a recirculated air inlet 116. The fresh and recirculated airflows F1, R2 are mixed within the mixing chamber 106 to create a fresh/recirculated air mixture that is supplied through the mixed air outlet 118 of the mixing chamber 106 into the recirculation blower 126, and via the mixed blower 126 into the cabin 18 of the work vehicle 10.

Similarly, at (304), the method 300 may include supplying an airflow exhausted from an outlet of the recirculating chamber into the cabin of the work vehicle. For instance, as indicated above, the recirculating chamber 104 may be configured to receive a recirculated airflow R1 via a recirculated air inlet 108. The recirculated airflow R1 is then supplied through the recirculated air outlet 110 of the recirculating chamber 104 into the recirculation blower 126, and via the recirculation blower 124 into the cabin 18 of the work vehicle 10. The recirculated airflow R1 from the recirculating chamber 104 and the fresh/recirculated air mixture F1, R2 from the mixing chamber 106 are only mixed once in the cabin 18 of the work vehicle.

Moreover, at (306), the method 300 may include receiving airflow data indicative of an airflow parameter associated with operation of the airflow control system. For example, as described above, the controller 202 may receive airflow data from sensor(s) 210, where the airflow data may correspond to pressure data received from the pressure sensor(s) 210, with the pressure data being indicative of the air pressure within the cabin 18 of the work vehicle 10. Additionally, or alternatively, the controller 202 may receive airflow data from sensor(s) 212, where the airflow data may correspond to flowrate data received from the flowrate sensor(s) 212, with the flowrate data being indicative of the flowrate of the fresh airflow F1 through the fresh air inlet 114.

Additionally, at (306), the method 300 may include actuating the gate relative to the recirculated air inlet to adjust an amount of recirculated air received within the mixing chamber via the first recirculated air inlet based at least in part on the airflow data. For instance, as indicated above, when the airflow parameter differs from the parameter threshold, the controller 202 may be configured to control the operation of the actuator 132 to move the gate 128 between its fully opened and fully closed positions. For example, when the pressure within the cabin 18 falls below the cabin pressure threshold and/or when the flowrate of the fresh airflow F1 falls below the flowrate threshold, the controller 202 may be configured to move the gate 128 relative to the recirculated air inlet 116 of the mixing chamber 106 towards its fully closed position. Similarly, when the pressure within the cabin 18 exceeds the cabin pressure threshold and/or when the flowrate of the fresh airflow F1 exceeds the flowrate threshold, the controller 202 may be configured to move the gate 128 relative to the recirculated air inlet 116 of the mixing chamber 106 towards its fully opened position.

It is to be understood that the steps of the method 300 are performed by the controller 202 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the controller 202 described herein, such as the method 300, is implemented in software code or instructions which are tangibly stored on a tangible computer readable medium. The controller 202 loads the software code or instructions via a direct interface with the computer readable medium or via a wired and/or wireless network. Upon loading and executing such software code or instructions by the controller 202, the controller 202 may perform any of the functionality of the controller 202 described herein, including any steps of the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for controlling an airflow supplied to a cabin of a work vehicle, the system comprising:
a housing;
a mixing chamber defined by the housing and comprising a fresh air inlet, a first recirculated air inlet, and a mixed air outlet, the mixing chamber being configured to receive fresh air via the fresh air inlet and recirculated air via the first recirculated air inlet, the fresh air being mixed with the recirculated air within the mixing chamber to create a fresh/recirculated air mixture that is supplied through the mixed air outlet;
a recirculating chamber defined by the housing and isolated from the mixing chamber, the recirculating chamber comprising a second recirculated air inlet and a recirculated air outlet, the recirculating chamber being configured to receive recirculated air via the second recirculated air inlet and supply the recirculated air through the recirculated air outlet;
a first blower coupled to the mixed air outlet of the mixing chamber;
a second blower coupled to the recirculated air outlet of the recirculating chamber;
a gate movable relative to the first recirculated air inlet to adjust an amount of recirculated air supplied to the mixing chamber; and
an actuator configured to actuate the gate relative to the first recirculated air inlet.

2. The system of claim 1, further comprising a controller in communication with the actuator, the controller being configured to control the operation of the actuator to actuate the gate relative to the first recirculated air inlet to adjust the amount of recirculated air supplied to the mixing chamber.

3. The system of claim 2, further comprising a pressure sensor configured to generate pressure data indicative of a pressure within the cabin of the work vehicle, wherein the controller is configured to receive the pressure data from the pressure sensor and control the operation of the actuator to actuate the gate relative to the first recirculated air inlet to adjust the amount of recirculated air supplied to the mixing chamber based at least in part on the pressure within the cabin.

4. The system of claim 3, wherein the controller is configured to control the operation of the actuator to actuate the gate relative to the first recirculated air inlet when the pressure within the cabin differs from a cabin pressure threshold.

5. The system of claim 1, wherein the gate is movable between a fully opened position and a fully closed position, the first recirculated air inlet being closed such that the mixing chamber receives no recirculated air when the gate is in the fully closed position.

6. The system of claim 5, wherein the actuator is a rotary actuator, the actuator being configured to rotate the gate about an axis between the fully opened position and the fully closed position.

7. The system of claim 1, wherein the gate is coupled to the housing.

8. The system of claim 1, wherein the fresh air inlet and the first recirculated air inlet are separately connected to the mixing chamber, and
wherein the fresh air inlet is always fully open.

9. The system of claim 1, wherein the fresh air is received from outside of the cabin of the work vehicle and the recirculated air is received from inside the cabin of the work vehicle.

10. A work vehicle, comprising:
a cabin; and
an airflow control system comprising:
a housing;
a mixing chamber defined by the housing and comprising a fresh air inlet, a first recirculated air inlet, and a mixed air outlet, the mixing chamber being configured to receive fresh air via the fresh air inlet and recirculated air via the first recirculated air inlet, the fresh air being mixed with the recirculated air within the mixing chamber to create a fresh/recirculated air mixture that is supplied through the mixed air outlet,
a recirculating chamber defined by the housing and isolated from the mixing chamber, the recirculating chamber comprising a second recirculated air inlet and a recirculated air outlet, the recirculating chamber being configured to receive recirculated air via the second recirculated air inlet and supply the recirculated air through the recirculated air outlet;
a first blower coupled to the mixed air outlet of the mixing chamber and configured to blow the fresh/recirculated air mixture from the mixing chamber into the cabin;
a second blower coupled to the recirculated air outlet of the recirculating chamber and configured to blow the recirculated air from the recirculating chamber into the cabin;
a gate movable relative to the first recirculated air inlet to adjust an amount of recirculated air supplied to the mixing chamber; and
an actuator configured to actuate the gate relative to the first recirculated air inlet.

11. The work vehicle of claim 10, further comprising a controller in communication with the actuator, the controller being configured to control the operation of the actuator to actuate the gate relative to the first recirculated air inlet to adjust the amount of recirculated air supplied to the mixing chamber.

12. The work vehicle of claim 11, further comprising a pressure sensor configured to generate pressure data indicative of a pressure within the cabin of the work vehicle, wherein the controller is configured to receive the pressure data from the pressure sensor and control the operation of the actuator to actuate the gate relative to the first recirculated air inlet to adjust the amount of recirculated air supplied to the mixing chamber based at least in part on the pressure within the cabin.

13. The work vehicle of claim 10, wherein the gate is movable between a fully opened position and a fully closed position, the first recirculated air inlet being closed such that the mixing chamber receives no recirculated air when the gate is in the fully closed position.

14. The work vehicle of claim 10, wherein the fresh air inlet and the first recirculated air inlet are separately connected to the mixing chamber, and
wherein the fresh air inlet is always fully open.

15. A method for adjusting the proportion of recirculated air to fresh air received within an airflow control system for subsequent delivery to a cabin of a work vehicle, the airflow control system comprising a housing defining a mixing chamber and a recirculating chamber, the mixing and recirculating chambers being isolated from each other, the mixing chamber comprising a fresh air inlet and a first recirculated air inlet, the mixing chamber being configured to receive fresh air via the fresh air inlet and recirculated air via the first recirculated air inlet, the recirculating chamber comprising a second recirculated air inlet through which it is configured to receive recirculated air, the airflow control system further comprising a gate movable relative to the first recirculated air inlet to adjust an amount of recirculated air supplied to the mixing chamber, the method comprising:
supplying an airflow exhausted from an outlet of the mixing chamber into the cabin of the work vehicle;
supplying an airflow exhausted from an outlet of the recirculating chamber into the cabin of the work vehicle;
receiving, with a computing device, airflow data indicative of an airflow parameter associated with operation of the airflow control system; and
actuating, with the computing device, the gate relative to the first recirculated air inlet to adjust an amount of recirculated air received within the mixing chamber via the first recirculated air inlet based at least in part on the airflow data.

16. The method of claim 15, further comprising comparing, with the computing device, the airflow parameter to a predetermined parameter threshold,
wherein actuating the gate comprises actuating the gate when the airflow parameter differs from the predetermined parameter threshold.

17. The method of claim 16, wherein actuating the gate comprises actuating the gate when the airflow parameter differs from the predetermined parameter threshold by a given amount.

18. The method of claim 16, wherein, when the airflow parameter comprises a pressure within the cabin.

19. The method of claim 18, wherein actuating the gate comprises actuating the gate towards a fully closed position when the pressure within the cabin falls below the parameter threshold, and
wherein actuating the gate comprises actuating the gate towards a fully opened position when the pressure within the cabin exceeds the parameter threshold.

20. The method of claim 15, wherein the gate is movable between a fully opened position and a fully closed position, the first recirculated air inlet being closed such that the mixing chamber receives no recirculated air via the first recirculated air inlet when the gate is in the fully closed position.
